(19) United States
(12) Patent Application Publication
(10) Pub. No.: US 2003/0014436 A1
(43) Pub. Date: Jan. 16, 2003

(54) Closed-loop delivery to integrated download manager

(76) Inventors: Donald J. Spencer, San Jose, CA (US); William H. Lutton, Fort Colling, CA (US); Michael M. Hsu, San Jose, CA (US); Glenn A. Anderson, San Jose, CA (US); Dennis J. McMahon, Tracy, CA (US); Anthony J. Schaller, Alameda, CA (US)

Correspondence Address: FISH & RICHARDSON P.C., 500 ARGUELLO STREET, SUITE 500, REDWOOD CITY, CA, 94063, US

(21) Appl. No.: 09/894,976

(22) Filed: Jun. 27, 2001

(51) Int. Cl. G06F 17/30

(52) U.S. Cl. 707/501.1

(57) ABSTRACT

Methods, apparatus and system, including computer program products, implementing and using techniques for delivery of media files to a particular digital media playback device. The system comprises a content server and a download manager located in the digital media playback device. The content server receives device-identifying information obtained from the digital media playback device, and distributes media files in response to the received device-identifying information. The download manager forwards device-identifying information to the content server over a public communication network and receives media files over the public communication network from the content server for playback on the particular digital media playback device.

### BACKGROUND

This invention relates to downloading of audio files through a computer network.

Music and other types of audio recordings are conventionally sold to consumers through stores or mail order companies. When music or audio recordings are sold through these types of outlets, the recordings are usually distributed on tangible media such as compact discs, magnetic cassette tapes, digital tapes, and so on. These formats for audio distribution generally give the music distributors precise information regarding the number of copies that have been sold of a particular album or recording, and thus what royalty should be paid on the recording.

However, a number of costs are associated with the types of retail sale of music mentioned above. For example, the tangible media must be packaged, and there are costs associated with inventory control, retail floor space, merchandise returns and so on. This will result in a higher price for the end consumers. In addition to the cost aspect, a further problem is that the music is only accessible for customers who have physical access either to the stores that sell the available music recordings or to the mail order outlets that present the available music recordings.

One approach to making recordings available to a larger group of customers is to receive orders and distribute music electronically over a communications network, such as the Internet. A person can connect to a music provider and download music over the Internet, either for free or for a fee. A few examples of common providers that make digital audio files available for downloading are RealNetworks Inc., Audible Inc., mp3.com Inc., and Emusic.com Inc. The downloaded music can be played back with appropriate audio playback software on the user's computer, either while the user's computer is connected to the Internet (that is, through streaming playback of the audio data), or at a later time. Examples of common software for playing back audio files include the RealPlayer® and the Windows® MediaPlayer™ software.

A user may organize his or her downloaded audio files in a “personal jukebox” on his or her computer. The user may also optionally transfer the downloaded audio files from his or her computer to a portable player that can play back digital audio files, so that he or she can leave his or her computer and still be able to listen to the previously downloaded audio files. A drawback of the wide availability and the easiness of copying the digital audio files is, that illegal copying of audio files is widespread. Therefore, the recording industry is reluctant to release audio recordings in formats other than the tangible ones discussed above, and customers may not have the option to download their favorite music over the Internet. If the music is available for download, the cost for the consumer will likely be higher than necessary, since the music distributors need to cover the loss in sales that arises when illegal copies are made and distributed to a large number of potential customers. Consequently, there is a desire on the consumer side for having a wide variety of music accessible for downloading over the Internet, as well as a need on the producer side to control the distribution of music files to the end users in order to prevent illegal copying after the music has been downloaded.

### SUMMARY

In general, in one aspect, this invention provides methods, apparatus, and systems, including computer program products, implementing and using techniques for delivery of media files to a particular digital media playback device. A content server receives device-identifying information obtained from a particular digital media playback device and distributes media files in response to the received device-identifying information. A download manager located in the digital media playback device forwards device-identifying information to the content server over a public communication network and receives media files over the public communication network from the content server for playback on the particular digital media playback device.

Advantageous implementations can include one or more of the following features. The content can include a user database containing user information uniquely identifying one or more users, a content database containing multiple media files and metadata associated with each media file of the multiple media files, a usage rights database containing usage rights information for each media file in the content database, a license server for issuing content-enabling licenses, a device database containing device information uniquely identifying one or more device types and an application server operable to communicate with the user database, the content database, the license server, the usage rights database, the device database and the download manager.

The application server can perform the following steps in response to a request for one or more media files from the download manager: obtain user information from the user database based on the device-identifying information; obtain one or more encrypted media files and metadata associated with the encrypted media files from the content database; obtain usage rights information for the one or more encrypted media files from the usage rights database; obtain device information from the device database. The device information describes functional capabilities of the digital media playback device; forward the obtained user and device information to the license server and receive a license for the encrypted digital media files and distribute the encrypted media files and the license to the download manager over the public communication network.

Alternatively, the application server can use the license to decrypt the encrypted media files using the received license; re-encrypt the decrypted media files, using the device information and usage rights information, to a file format that is playable only on the particular digital media playback device, and distribute the re-encrypted media files to the download manager over the public communication network.

The application server can perform the following steps in response to a request for one or more media files from the download manager: obtain user information from the user database based on the device-identifying information; obtain one or more media files and metadata associated with the media files from the content database; obtain usage rights information for the one or more media files from the usage rights database; obtain device information from the device database, the device information describing functional capabilities of the digital media playback device; forward the obtained user and device information to the license server and receive a license for the digital media files and distribute the media files and the license to the download manager over the public communication network.

The application server can perform the following steps in response to a request for one or more media files from the download manager: obtain user information from the user database based on the device-identifying information; obtain one or more media files and metadata associated with the media files from the content database; obtain usage rights information for the one or more media files from the usage rights database; obtain device information from the device database, the device information describing functional capabilities of the particular digital media playback device; encrypt the media files, using the device information and usage rights information, to a file format that is playable only on the digital media playback device and distribute the encrypted media files to the download manager over the public communication network.

The user database can contain offer information. The device database can contain device information uniquely identifying one or more type of devices, the device information comprising make, model, manufacturer, and functional characteristics. The content server can include a web (World Wide Web) server that is connected to the application server and to the public communication network, thereby allowing a user to communicate with the content server through a web browser. The web server can provide representations of media files that are playable on the particular digital media playback device, the representations being operable to be viewed by the user in the web browser. The application server can receive user requests for controlling the function of the digital media playback device, the user requests being supplied by a user through the web browser and generate control commands to the download manager, the control commands instructing the download manager to carry out the user requests on the digital media playback device. The media file formats can include MP3 files, WMA files, SAF files, BMT files, RM files, and VQF files.

The digital media playback device can be a portable device for playback of media files, a non-portable home sound reproduction system, a cellular telephone, a television set top box, a web pad, an Internet radio device, a hybrid device, or a digital media playback module. The device-identifying information can obtained from a removable nonvolatile storage medium in the digital media playback device. The device-identifying information can include a unique identification number obtained from the digital media playback device, such as a serial number. The device-identifying information can also include a state of a nonvolatile storage medium (for example how much memory is free and what content is stored in the memory) in the digital media playback device. The public communication network can be the Internet.

The invention can be implemented to realize one or more of the following advantages. The invention provides a delivery mechanism capable of providing digital music in a format that can be correctly rendered only on a designated device. It also provides a method for controlling a designated device from a remote server, in accordance with user instructions or predetermined business rules. It saves valuable disk space at the provider end of the system since only one copy of the music needs to be stored and can be linked to several licenses.

The details of one or more embodiments of the invention are set forth in the accompanying drawings and the description below. Other features and advantages of the invention will be apparent from the description and drawings and from the claims.

### DESCRIPTION OF DRAWINGS

FIG. 1 is a schematic diagram showing a closed loop delivery system in accordance with the invention.

FIGS. 2A and 2B are flowcharts showing two processes for downloading audio files in a closed loop delivery system in accordance with the invention.

FIGS. 3A and 3B are schematic views showing a download manager in accordance with the invention.

Like reference symbols in the various drawings indicate like elements.

### DETAILED DESCRIPTION

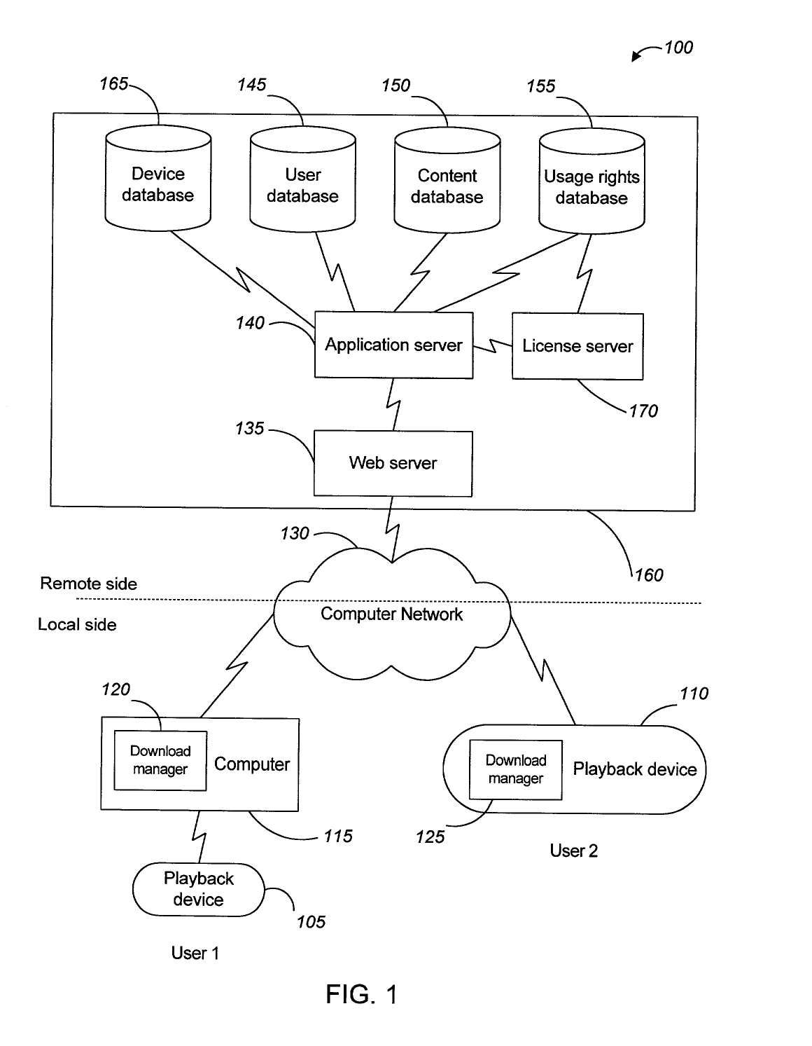

The invention will be described below by way of example of audio files and audio content and a digital audio playback device. However, the invention is applicable to other types of media files, such as video files, and corresponding media playback devices for playing back files of this type. As can be seen in FIG. 1, a system (100) for closed loop delivery of audio files in accordance with the present invention has a local side and a remote side. Closed loop delivery (CLD) refers to the process of delivering data from a server to a unique, designated destination device. In the CLD system each destination device is either a secure end node or non-secure end node. In the case of a secure end node, the audio files can only be accessed or correctly rendered on the destination playback device, and the delivery and playback of the audio files is restricted by rules set up by the audio file provider. Furthermore, the downloaded audio files that are stored on the playback device cannot easily be extracted from the playback device and sent to another destination. The concepts local side and remote side of the CLD system are used here from a system user's (that is, consumer's) point of view.

In one implementation of the system, the remote side includes a content server (160) that interacts with the users' playback devices during a closed loop delivery of audio files to the users' audio playback devices. The content server (160) includes a web server (135), an application server (140), a user database (145), a content database (150), a device database (165) and a license server (170) with an associated usage rights database (155). The different components of the content server may be integrated into one or several physical units, depending on the needs of the service provider, and the boxes can be connected with conventional communication links. The devices at the local side of the system include devices that belong to one or more of the users, such as a digital audio playback device (105, 110) and optionally a computer (115) or other intermediary device, such as a set top box. Only two users, User 1 and User 2 are illustrated in the system (100) shown in FIG. 1, but many users are typically connected at any given time.

Many other configurations of the CLD system in accordance with the invention are possible, as will be clear from the following description. Furthermore, throughout this specification, reference will be made to “audio files” or “digital audio files.” Audio in this context refers to any audible content, tone, or sound, regardless of how the audio has been generated. Audio includes, for example, music, songs, tunes, tracks, titles, voice, speech, and other content similar or analogous to content that may be provided by a broadcast radio station.

At the remote side of the closed loop system, the web server (135) is the part of the content server (160) that is used to provide a user interface between the users that are connected to the computer network (130) and the application server (140), which constitutes the central part of the content server, as will be seen below. A user can view web pages that are related to the closed loop delivery system, either in a web browser on his or her computer, or on a simplified display on a playback device, such as a home stereo or a personal digital assistant (PDA), for example. The available web pages include pages of three categories: web pages that are associated with a shopping cart and used for selecting audio files to download, web pages that are associated with the management of a personal user account, and web pages that are associated with customer service tools. All these web pages implement conventional functionality, and they will therefore not be described in any detail, but rather just referred to in the following tables. Table 1 shows the pages that are associated with the shopping cart, table 2 shows the pages that are associated with the user account management, and table 3 shows the pages that are associated with the customer service functions at the web site hosted on the web server.

TABLE 1
Web pages associated with the shopping cart

| | | | Possible user |
|---|---|---|---|
| Page | Purpose | Items displayed | actions |
| Search | Allows a user to | Track name | Proceed to |
| and browse | browse and search | Artist name | check-out |
| shopping | for audio files. | DRM (Digital | |
| cart frame | Keeps a tab of items | Rights Manage- | |
| | that have been added | ment) | |
| | to the shopping cart. | Price | |
| | | Currency | |
| | | Total | |
| | | Proceed to check- | |
| | | out | |
| Shopping | Allows a user to see | Track name | Remove |
| cart | more details on the | Artist name | Remove all |
| summary | tracks selected. | DRM | Continue |
| page | Shows the total and | Download size | shopping |
| | allows a user to | Price | Proceed to |
| | remove any items | Currency | check-out |
| | before proceeding | Total | |
| | with check-out. | | |
| User | Secure login of a | Email address edit | Forgot your |
| login | user or register a new | box | password? |
| page | user. | Password edit box | New user |
| | | | Login |
| Payment | Collects credit card | Last 4 digits and | Choose |
| information | information to pay | expiration date for a | credit card |
| page | for contents in the | selected number of | Edit existing |
| (secure) | shopping cart, as | credit cards | or add new |
| | well as promotional | belonging to a user | credit card |
| | codes and gift | Name on credit | Proceed to |
| | certificates. | card (editable field) | check-out |
| | | Billing address | |
| | | (several editable | |
| | | fields) | |
| Order | Confirms the order | Confirmation of | Order now |
| summary | with the user a final | user information | button |
| page | time. Upon clicking | Confirmation of | Cancel/Edit |
| | “order now” the | track selection and | order button |
| | credit card | total due for “pay | |
| | transaction is | now items” | |
| | approved, and an | Confirmation of | |
| | email is sent out to | credit card | |
| | the user with order | information for “pay | |
| | and support | now items” | |
| | information. | Confirmation of | |
| | | track selection and | |
| | | total due for “pay | |
| | | later items” | |
| Order | Displays the track list | Order number | Download |
| download | information for a | Order date | now by each |
| page | given order. Can be | Links for each | track, |
| | accessed via the | track/offer in cart | collection |
| | user's account | Download count | (album), or |
| | management tools | Last downloaded | entire order |
| | and the order e-mail. | date/time | Back to |
| | Keeps a count on | | storefront |
| | how many times | | button |
| | tracks/licenses/offers | | |
| | have been | | |
| | downloaded and the | | |
| | date for the latest | | |
| | download. | | |
| | References software, | | |
| | help and support for | | |
| | the digital downloads | | |
| | to work. | | |

Table 2 below shows a summary of the pages that are associated with the user account management. Pages that require secure login are marked with an asterisk.

TABLE 2
Web pages associated with user account management

| | | | Possible user |
|---|---|---|---|
| Page | Purpose | Items displayed | actions |
| User login | Secure login of the | Email address edit | Forgot your |
| page | user | box | password? |
| | | Password edit box | New user |
| | | | Login |
| New user | Registers users on | First name | View site |
| registration | the site and any of | Last name | privacy policy |
| | the network sister | Email address (as | Ok |
| | sites | username) | |
| | | Confirm email | |
| | | Password | |
| | | Confirm Password | |
| | | Zip code | |
| | | Country | |
| | | Yes/No to | |
| | | marketing emails | |
| | | 13 year old or | |
| | | older? | |
| User account | Main menu for users | | See order |
| page | to view/edit/access | | history |
| | their information | | List track |
| | | | history |
| | | | Change name/ |
| | | | email |
| | | | Change |
| | | | password |
| | | | Edit/delete |
| | | | credit cards |
| Order history | Lists history of | Order list by | Click on any |
| page* | orders | number | order/RMA to |
| | | Order dates | view details |
| | | RMA list by | |
| | | number | |
| | | RMA date | |
| Order page* | Lists order or RMA | Order number | Download now |
| | details | Order date | by each track/ |
| | | Links for each | offer |
| | | track/offer in cart | |
| | | Download count | |
| | | Last download | |
| | | date/time | |
| List track | Lists all tracks | Track name | Download now |
| history* | | Artist name | by each track/ |
| | | Order number | offer |
| | | Links for each | |
| | | track/offer in cart | |
| | | Download count | |
| | | Last download | |
| | | date/time | |
| Change | Changes login name | First name | Cancel |
| name/e-mail | or email | Last name | Submit |
| page* | | E-mail address (as | |
| | | username) | |
| | | Confirm E-mail | |
| | | address | |

Table 3 below shows the pages that the websites the customer service representatives can access in order to provide customer service at the web site hosted on the web server.

TABLE 3
Web pages associated with customer service functions

| | | | Possible user |
|---|---|---|---|
| Page | Purpose | Items displayed | actions |
| Customer | Allows a customer | Username | Submit |
| service | service representative | Password | |
| representative | to log in | | |
| login page | | | |
| User search | If the user has a valid | Email, or | Submit |
| page | order or RMA | First Name and | |
| | number, submitting | Last name, or | |
| | the number takes the | Order/RMA | |
| | customer | number | |
| | representative | | |
| | directly to the user's | | |
| | order page | | |
| User search | With the information | List of results | Select user |
| results page | on this page, a | by name | Back to search |
| | customer service | Last name | page |
| | representative can | First name | |
| | verity and identify | E-mail | |
| | the user either by | Zip Code | |
| | address or zip code | Address | |
| Menu page | | Last name | Change name/ |
| | | First name | e-mail or forgot |
| | | Confirm e-mail | password |
| | | Zip Code | Order History |
| | | Address | |
| Change name/ | | Last name | Submit changes |
| e-mail or forgot | | First name | Send password |
| password page | | Confirm e-mail | to e-mail above |
| | | Zip Code | |
| Order history | With the information | Last name | Click on order |
| page | on this page, a | First name | to access credit |
| | customer service | E-mail | or download |
| | representative can | Zip Code | history (takes |
| | verity and identify | Address | the customer |
| | the user either by | Order/RMA | service |
| | address or zip code | history (order/ | representative |
| | | RMA number, | to the order/ |
| | | order/RMA | RMA page |
| | | date, | below) |
| | | order/RMA | |
| | | total) | |
| Order/RMA | | Last name | Refund tracks |
| page | | First name | selected |
| | | E-mail | Reset |
| | | Zip Code | download |
| | | Address | number on |
| | | Order/RMA | selected tracks |
| | | number | |
| | | Order/RMA | |
| | | date | |
| | | Order/RMA | |
| | | total | |
| | | Track history | |
| | | (name, DRM | |
| | | and other | |
| | | information, | |
| | | size of | |
| | | download, | |
| | | price, | |
| | | download | |
| | | count, last | |
| | | download | |
| | | date/time, | |
| | | notes) | |
| Refund page | Reason needs to be | List of results | Choose reason |
| | selected before a | by name | Cancel |
| | customer service | Last name | Refund now |
| | representative can | First name | |
| | process the refund | E-mail | |
| | request | Zip Code | |
| | | Address | |
| | | Order number | |
| | | Refund number | |
| | | Track | |
| | | information | |
| | | (name and | |
| | | price) | |
| | | Total refund | |
| | | Credit card | |
| | | being refunded | |
| | | (last 4 digits | |
| | | and expiration | |
| | | date) | |
| Reset | | Last name | Choose reason |
| download page | | First name | Cancel |
| | | E-mail | Reset now |
| | | Confirm e-mail | |
| | | Zip Code | |
| | | Track list to be | |
| | | reset | |

A special feature of the web server is that it is operable to provide a simulated instant response when a user attempts to download audio files to a digital audio playback device. The user selects one or more files to download using a web browser window. When the user submits the request, the web server opens a hidden window identical to the visible web browser window and starts generating the response to this hidden window. While the response is being generated, the web server generates a simulated response in the web browser window that is visible to the user. This shows the user that his or her request is being carried out, even when the server is idle and waits for a response from, for example, the user database, the content database or the rights server. When the real response from the server is complete in the hidden window, the visible window is updated with this real response if it differs from the simulated response. Additional functions of the web server will be described below with reference to two examples showing two processes for downloading audio files to a playback device.

As was explained above, the web server (135) communicates with the application server (140). The application server does not allow any direct user interaction. Any commands a user wishes to send to the application server have to go through a download manager and/or the web server. The application server acts as a coordinator for the content server (160) and has the ability to communicate with download managers (120, 125) on the local side of the CLD system, the web server (135), the user database (145), the content database (150), the device database (165) and the license server (170) with its associated usage rights database (155) on the remote side of the CLD system. The functionality of the application server will be described below in the context of an example showing how a user can download digital audio files. The description of the CLD system will now continue with the user database (145), the content database (150), the device database (165) and the license server (170) with its associated usage rights database (155).

The user database (145) can be implemented in any conventional way. Before a user can start using the closed-loop delivery system, he or she has to provide personal information and information relating to his or her digital media playback device(s). Examples of such information include user name, address, age, email address, registered devices (unique identifier, make, model), user profile information, and so on. From the CLD point of view, the most important information in the user database is what devices are associated with the different users. This information provides the necessary basis for implementing business rules that govern what audio files a particular user can download to a particular playback device. In one implementation, the download manager (which will be described below) supplies the device information automatically when a user connects a playback device to the network, either directly or through a pass-through device.

The content database (150) is a database in which the audio files and associated metadata are stored. Examples of metadata associated with the audio files include track name, artist, label, graphics, price, genre, and so on. The audio files in the content database can be stored in an unencrypted file format or in one or more encrypted file formats and can only be requested by the application server. Just like the user database (145), the content database (150) can be implemented in any conventional way. The system here will be described by way of example using two different Digital Rights Management (DRM) technologies, as provided by Microsoft or InterTrust. Other types of encryption and decryption system may be used.

The device database (165) contains device information that uniquely identifies one or more audio playback device types. The information in the device database (165) includes, for example, make, model, manufacturer, type (such as portable device, home stereo, set top box, and so on), hardware version history, firmware version history, and capabilities (such as CODECs, DRMs, bit rates supported, internal storage size, external storage type, and so on). Just like the databases described above, the device database (165) can be implemented in any conventional way. The application server (140) can retrieve information from the device database (165) that is necessary to determine what types of audio content a particular type of digital audio playback device can play back.

The last part of the content server (160) to be described here is the license server (170) and its associated usage rights database (155). The usage rights database (155) contains usage rights and for the audio content in the content database. The license server (170) receives requests for licenses from the application server (140) and issues licenses in response to the requests, based on the information in its associated usage rights database (155). A license includes a decryption key that can decrypt a particular audio file and specifies the rights that are associated with the audio file for a particular user. For example, a license can allow an audio file to be transcrypted (that is, decrypted then re-encrypted), which is the case with InterTrust's DRM, or a license can be a one time use key that is needed to export an audio file to a particular device, which is the case with Microsoft's DRM. The role of the content database and the license server will be explained in more detail below as two examples of download processes are presented.

The computer network (130) between the users and the content server (160) can be any type of computer network ranging in size from a local area network to the Internet, having multiple nodes at which a user can connect a playback device. A download manager, either in the playback device or in a computer or other intermediary device to which the playback device is temporarily attached, always identifies the playback device to the application server, as will be described later. This makes it possible for a user to connect to the content server from any node in the computer network, which provides a significant advantage compared to conventional systems where users are limited to connecting from the same location every time. As was seen above, in conventional systems, a user is limited to using his or her own computer, since the audio files have to be stored on the computer hard drive before they can (optionally) be transferred to a portable playback device.

Looking now at the local side of the CLD system in FIG. 1, each user has a temporarily or permanently connected playback device (105, 110), which is a secure or non-secure end node in the CLD system (100). The audio files that a user may download can reach the end node (that is, the audio playback device), in different ways. For example, User 1 has a personal computer that acts as a pass-through device for downloaded audio files on their way to the playback device, while User 2 has a playback device to which audio files can be downloaded directly without passing through a computer. A few examples of secure end nodes are portable digital audio playback devices, such as the portable SonicblueRio®600 and 800 players, the Compaq® iPaq PA-1 player, and the Nike® PSA™ player. Other examples include devices such as set top boxes, home stereo systems, web pads, Internet radio devices, and hybrid devices, that is, conventional consumer electronics devices that have added capability of playing back audio content. An example of a hybrid device would be an Internet fax machine that has been provided with the appropriate components for playing back or transferring digital music. All of these devices are secure in the sense that data cannot easily be extracted from them and passed onto another destination without significant effort and expertise. No commonly available applications exist that allow the extraction of DRM-protected data from digital audio playback devices of the types mentioned above. Furthermore, building a custom application for the purpose of extracting and decrypting audio files from a playback device would require advanced knowledge about the file storage methods and the DRM system used by the respective audio playback devices. The secure end node may alternatively be a memory card that is uniquely addressable and that can be used in different types of playback devices. Likewise, the pass-through device does not have to be a personal computer, but can, for example, be a home audio entertainment system or a set top box to which a playback device is temporarily attached.

As can be seen in FIG. 1, both the User 1 configuration and the User 2 configuration contain a download manager (120, 125). The download manager is a software application or component whose purpose is to facilitate downloading of audio files to the secure or non-secure end node by coordinating the dialog between the end node (105, 110) and the application server.

In the User 1 implementation, the download manager (120) resides on the computer or on another pass-through device (115) to which a playback device (105) is temporarily attached, for example through a USB (universal serial bus) interface, and in the User 2 implementation the download manager resides on the playback device (110). The download manager registers with the application server when User 1 connects a playback device to the computer (or alternatively when User 2 connects the playback device to a node in the network) and identifies the connected device to the application server using a unique feature of the device, such as the serial number of the device or of the memory card residing inside the device. The function of the download manager is the same in both implementations, so only one description of an implementation of the download manager will be given.

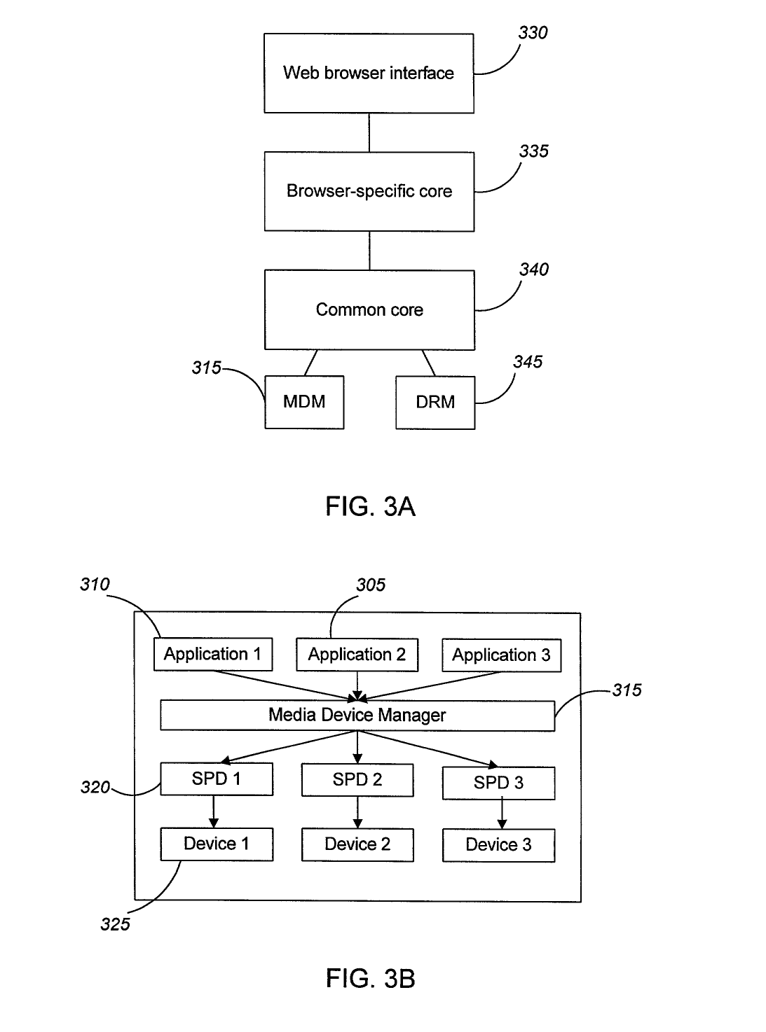

In the User 1 configuration, the download manager is implemented as a plugin (a pre-compiled software component) in a conventional web browser. A conceptual view of the download manager plugin is shown in FIG. 3A. The download manager contains a web browser interface (330), which is code that is associated with the download manager's appearance on a user's display. Inside this code, there is a browser-specific core (335) that is coded specifically to the web browsers being supported. For example, there is an Internet Explorer version (activeX) and a Netscape version (plug-in). Inside the browser-specific core, there is a common core (340). The common core (340) is not specific to any browser and offers a common set of services (that is, properties and methods) that can be used by the browser-specific components. The common core also forms the interface to the Media Device Manager MDM (315) and the DRM (345). The MDM application programming interface (API) includes a collection of interfaces and methods that allow an application to enumerate and control playback devices. The MDM API will be described in further detail below. The Digital Rights Management (DRM) code will be described when the download process is described below.

The download manager's properties and methods accomplish the following: querying device information; initiating and control the downloading of audio content; determining a download state and progress; controlling attached playback devices; error reporting; managing the playback device's audio content (that is, its file system on the audio playback device); and maintaining a user's preferences. Table 4 and Table 5 below contain a more detailed summary of the download manager properties and methods.

TABLE 4
Download Manager Properties

| Download manager | |
|---|---|
| property | Description |
| HasMDM | Read this property to determine whether the MDM |
| | is installed on the user's computer. |
| Config | Read this property to get the configuration string |
| | for the MDM. |
| DeviceCount | Read this property to determine how many playback |
| | devices are attached to the user's computer and |
| | are present. |
| DeviceName | Read this property to get the name of an attached |
| | playback device. |
| DeviceId | Read this property to get the ID of the currently |
| | attached playback device. |
| ManufacturerID | Read this property to get the ID of the manufacturer |
| | of the currently attached playback device. |
| StorageCount | Read this property to get the number of top-level |
| | storage media that are available on a given playback |
| | device. |
| StorageName | Read this property to get the name of a specific |
| | top-level storage media on a given playback device. |
| FreeMemory | Read this property to get the number of bytes of free |
| | memory on a specific storage media on a given |
| | playback device. |
| TotalMemory | Read this property to get the number of bytes of |
| | memory, both free and used, on a specific storage |
| | on a given playback device. |
| Status | Read this property to discover the status of the last |
| | download operation. |
| Stage | Read this property to discover the stage of the last |
| | download operation. |
| ProgressFile | Read this property during a download operation to |
| | get the name of the audio file being downloaded. |
| ProgressCurTicks | Read this property during a download operation to |
| | get the completed number of progress ticks for |
| | the currently downloading audio file. |
| ProgressTotalTicks | Read this property during a download operation to |
| | get the total number of progress ticks for the |
| | currently downloading audio file. |
| ProgressDest | Read this property during a download operation to |
| | get the path or playback device name to which the |
| | audio file is being downloaded. |
| ErrorCode | Read this property when an error has been reported |
| | by Status to get the error code. |
| ErrorSubCode | Read this property when an error has been reported |
| | by Status to get the sub error code. |
| ErrorString | Read this property when an error has been reported |
| | by Status to get a string proving specific context |
| | sensitive information about the error. |
| PickDirectory | Read this property to allow the user to select a |
| | download directory. |
| Preferences | Read this property to get the value associated with a |
| | particular preference name. |
| VersionIsLess | Read this property to determine if a passed version |
| | string is “less” than the current version of the Active |
| | X control. Only implemented for the control, not the |
| | Plug-in. |

TABLE 5
Methods of the Download Manager

| Method | Description |
|---|---|
| Format | Call this method to format a specific top-level media |
| | on a given playback device. |
| Reset | Call this method to reset the MDM. |
| DownloadToDevice | Call this method to download a play-list to a specific |
| | storage on a given playback device. |
| DownloadToPath | Call this method to download a play-list to a specific |
| | path on the user's local storage. |
| Cancel | Call this method to stop the current download |
| | operation. |
| Resume | Call this method to resume suspended download |
| | operation. |
| SetPreference | Call this method to associate a value with a |
| | particular preference name. |

As was described above, the MDM API consists of a collection of interfaces and methods that allow an application to enumerate and control playback devices. The MDM architecture is based on the Component Object Model (COM) software architecture created by Microsoft Corporation that allows applications to be built from binary software components. Using COM as the programming model enables an API that is abstracted from the underlying implementation of the hardware, is extensible in nature for support of future devices, and has inherently strong version characteristics for backwards compatibility with older devices and forward compatibility for new features.

The MDM provides complete encapsulation of a playback device, the playback device being a hardware or software device. All of the normal operations of a device, such as discovering device properties, downloading files, and invoking the commands of a device, are organized into a collection of COM based interfaces, each having its own scope of functionality. One of the primary design benefits of a COM implementation is language independence. COM presents functionality to applications as an abstract concept of methods rather than a specific programming language syntax. All languages supported in the Microsoft Windows® environment support COM equally and independently and can take advantage of COM implementations such as the MDM equally and independently.

Furthermore, many script languages are capable of interaction with COM objects. For example, the XML script language is directly interoperable with COM and XML scripts are often referred to as COM Components written in a script language.

Designs based on COM are not restricted to a particular computing platform. The MDM implementation, for example, makes extensive use of macros and minimal use of hard coded values and statements in defining its COM constructs. As a result, porting the MDM to another computing platform, whether that platform supports COM or not, is primarily a task of redirecting the meaning of the macros.

Use of COM also reduces the burden on developers to anticipate design issues and requirements. In a COM based solution, existing COM objects can be revised and new COM objects can be introduced without impact on previously implemented objects.

The MDM lacks built-in mechanisms for handling policies or procedures that are associated with secured content. Consequently, all operations that need to be of a trusted level are managed by various applications, such as the download manager, that use MDM in conjunction with software that provides secure content.

Implementing the MDM under COM provides an additional level of binary component security in that COM binaries do not export their functions, but instead expose their function addresses only at run time. Therefore, static attacks on MDM implementations cannot be initiated by traditional methods of writing function trap style software that looks into program flow. COM objects also resist the approach of run time hook and call passing as a trapping mechanism since COM does not include a mechanism for allowing individual processes to interfere with other processes' access of COM interfaces. All of these features in a COM-based MDM implementation contribute to a robust environment for the safe implementation of devices, which will be used in applications where content ownership and rights have to be maintained.

There are essentially two types of COM interfaces that make up the MDM. The first type is the COM interfaces that an application program acquires to access and control playback devices, and the second type is the COM interfaces that the application itself may implement in order to enhance interaction with the MDM. The collective interfaces that the application acquires to access and control a playback device are organized in a hierarchical manner, as will be described below.

The iMediaDeviceManager is the primary COM interface, which can be accessed from within an application. The interface consists of methods for application certification and access to media playback device interfaces.

The iMediaDeviceManager is primarily responsible for providing the means for enumerating the playback devices that are installed and or present on the computer. Once media playback devices have been identified by the iMDMEnumDevice interface described below, the programmer is in possession of the top-level container of discrete playback devices, the iMDMDevice interface, which is also described below. Once a playback device's iMDMDevice interface has been acquired, the application can obtain device-specific information and status. The iMDMDevice interface is available in all MDM component objects. Furthermore, from within iMDMDevice, the application can obtain access to the device's storage component(s) through the iMDMEnumStorage interface, which returns the iMDMStorage interface, both of which are described below. The iMDMStorage interface exposes storage media on playback devices and the contents of those media.

Additional interfaces and methods exist that provide various device and storage medium control functions. The following list summarizes the purpose of the playback device interfaces of the MDM.

IMDMEnumDevice is used to identify installed devices and returns an iMDMDevice interface for a playback device installed on the system.

IMDMDevice provides methods for finding out global information about a playback device such as manufacturer, capabilities and status, as well as the means for authenticating a playback device.

IMDMDeviceControl provides methods for remote control of playback devices functions and control for streaming audio playback and recording. This interface is acquired from the iMDMDevice interface.

IMDMDeviceService provides methods for accessing service functions of devices such as clocks, fm tuners and control panels. This interface supports the following interfaces.

IMDMOpaqueAccess is used to access opaque or custom interfaces from the MDM and device specific layers of the MDM.

IMDMEnumStorage is used to identify the storage media on devices and returns an iMDMStorage interface for each storage medium found on a playback device. This interface is also used to identify objects on the storage media and returns an iMDMStorage interface for each object found on a storage medium. This interface is acquired from the iMDMDevice interface when referring to storage media and from the iMDMStorage interface when referring to content on media.

IMDMStorage provides methods for exposing information about storage media and objects on storage media. This interface is also used to access all other interfaces related to storage.

IMDMStorageGlobals provides global information about storage media and provides methods for performing operations such as formatting a medium. This interface is acquired from an iMDMStorage interface.

IMDMStorageControl provides the methods that are used to put content (objects) on a storage medium, take content off, and move content around on media. This interface is acquired from the iMDMStorage interface.

IMDMObjectInfo provides detailed information about media objects (for example, audio files) such as play lengths, track numbers, etc and is acquired by the iMDMStorage interface.

As stated, several interfaces are specified for the application to implement as a means of enhancing interaction with the MDM. Application-implemented COM interfaces are optional. The MDM can operate without interaction with application-implemented COM interfaces, but there are benefits to using the MDM together with application-implemented COM interfaces as the COM interfaces offer a substantially more detailed and efficient mode of interaction between applications and playback devices. The following summarizes the purpose of the application-implemented interfaces.

IMDMProgress is used to enhance progress communication with an application during long operations.

IMDMConnect is used to allow the application to sense disconnects of removable devices and removable media in devices.

IMDMOperation is used to allow the application to have a direct data pipeline with the MDM during transfer of content to or from a playback device.

IMDMOperation2, like IMDMOperation, is used to allow the application to transfer content to or from a device via a stream-based interface. However, this interface implements meta-data transfer as well as content.

As shown in FIG. 3B, when a call to one of the application interfaces (for example, an instruction from the application server to perform a certain task on the playback device) is received by the MDM (315), the MDM routes the instruction intended for one or more of these interfaces to a software module (320) that represents the playback device (325). These software modules are known as Service Provider Drivers (SPDs), or simply as drivers. An SPD (320) may be physically located on a computer or a different type of pass-through device, such as a set top box, or on the playback device itself. The driver is responsible for responding to calls from the MDM by communicating with the appropriate components in the playback device to perform the desired action. There may be many applications accessing the MDM and there may be many SPDs installed. Each SPD can be designed to support one or more types of playback device, or multiple devices of the same type.

There are also a number of interfaces that must be implemented to enable communication between the MDM and the different SPDs that are installed on the playback device or computer. These interfaces are known collectively as the Service Provider Interfaces (SPI), and are arranged in a hierarchical manner, similar to the MDM interfaces. The Service Provider Interfaces are simpler versions of the MDM interfaces. The following is a list of some of the more important Service Provider Interfaces:

ISpDriver is the top-most interface, an instance of which is the first point of contact between the MDM and the SPD. The primary responsibility of this interface is to provide device enumeration of the currently connected playback devices supported by this driver.

ISpDevice provides mechanisms for accessing global information about a playback device, such as manufacturer, capabilities and status. The ISpDevice is also responsible for providing a top-level enumeration of all the storage media, such as internal memory and removable memory that the playback device supports.

ISpDeviceControl, if implemented, provides methods for remote control of the playback device's functions such as control for streaming audio playback and recording.

ISpStorage is used to represent a single storage item such as a file system, a folder or an individual file. File systems and folders are containers that may also provide storage enumeration of the files and folders they contain.

ISpFileStream represents the actual data of a single file, and can be used to either write or read that data.

The download manager can thus, using the MDM API described above, obtain information from a playback device that uniquely identifies the playback device. It also can detect the current audio content, how the audio content is arranged on the playback device, and how much empty memory space is available on the playback device for new audio files. The download manager also can carry out instructions received from the application server on the playback device, such as adding, deleting, and rearranging audio files.

In the User 1 setup, the user may also set up a local cache on his or her computer (115), that is, set aside space on the hard drive for download manager caching purposes. The cache will keep an encrypted copy of the most recent audio files transferred from the application server to the playback device. When a given audio file is requested again, the system can simply transfer the audio file from the local cache to the playback device without having to download it again from the application server. The playback device of User 1 has to be connected to the application server over the network, so that the application server can verify that User 1 still is allowed to transfer the audio file to the playback device. However, there will be a significant saving of time compared to having to download the audio file again from the application server.

Another feature of the download manager is that the download manager can be used to perform scheduled downloads, for example, during off hours. This allows a user to download large amounts of data without having to be present during the download process. For example, in the case of a home stereo, the set of audio files residing on the stereo can be updated over night, so that the user has a new selection of songs to listen to every morning.

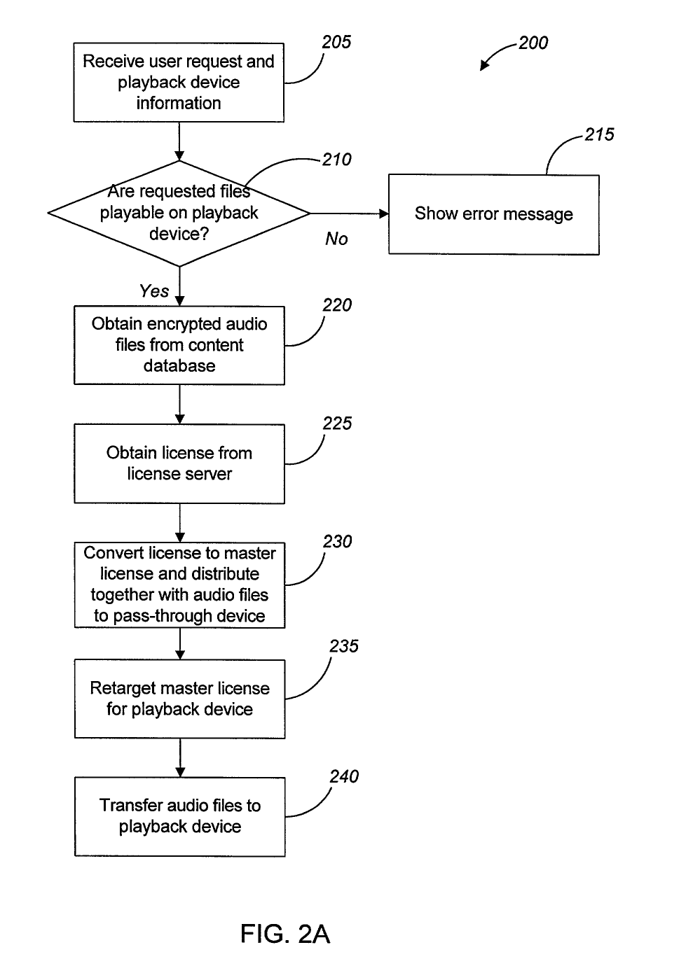

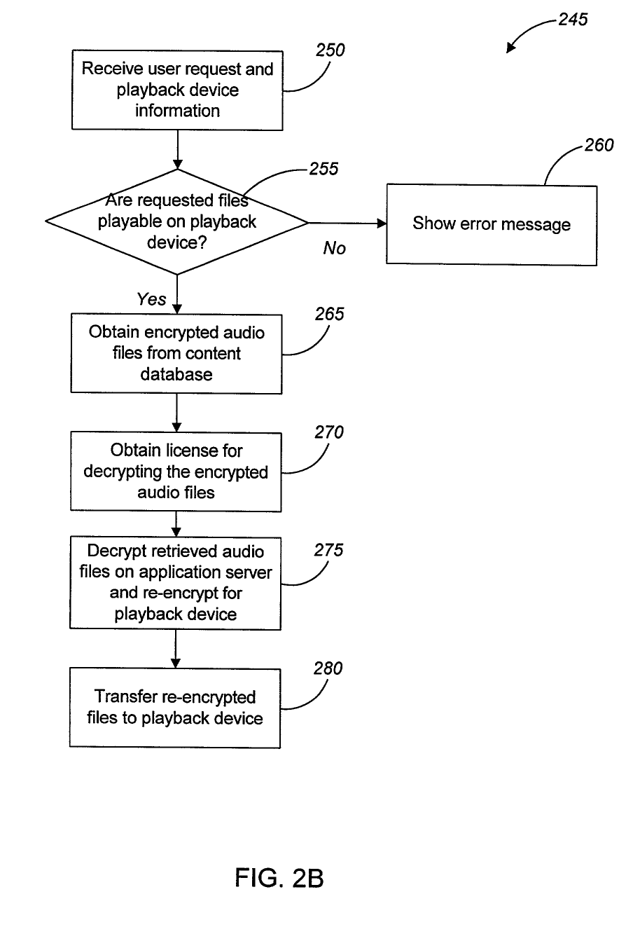

Two slightly different processes for downloading one or more digital audio files to a playback device using the closed loop system will now be described by way of example. The process shown in FIG. 2A illustrates the download process when a Microsoft DRM system and a pass-through device is used (corresponding to the setup for User 1 in FIG. 1), and the process shown in FIG. 2B illustrates the download process when an Intertrust DRM and a playback device directly connected to the computer network is used (corresponding to the setup for User 2 in FIG. 1). Additional download processes can be implemented as alternative DRM systems become available.

It is assumed that the user has registered himself or herself and at least one playback device, so that his or her user and device information exists in the user database and device database, respectively. It is further assumed that one or more playback devices are temporarily attached to the pass-through device or to directly to the computer network, and that the user and playback device has been identified to the application server. The authentication process for a digital audio playback device is actually a chain of authentications that include verification of the integrity of the download manager, the MDM core and the service provider driver(s), as well as key exchanges between the playback device and the service provider driver. The chain of authentications is as follows. When a playback device connects to the host—usually a computer—containing the service provider driver, the service provider driver authenticates the playback device and the playback device's ID. The download manager then verifies the integrity of the MDM core and service provider driver, and the application server finally verifies the download manager. Since the download manager is a secure application, this chain of verifications sets up a secure authenticated channel between the playback device and the application server that content and licenses may pass through.

As shown in FIG. 2A, the download process (200) starts with the receipt of a user request for one or more audio files to download (205). The user selects these audio files to be downloaded in a web browser window on his or her computer that is in communication with the web server (140 in FIG. 1). The audio files a user may select can either be a general selection of audio files presented by the system to the user, or can be a customized selection of audio files that is based on the user rights information contained in the user database (145 in FIG. 1), on the information in the device database (165) for the type of playback device connected, or on any other business rules determined by the service provider.

After the user has submitted his or her request to the application server, the application server checks whether the requested audio files are playable on the playback device (210). This check is based in part on how much storage space is available on the playback device, the capabilities of the device and the rules governing what audio files a certain user has permission to download. These rules may be related to the physical constraints of the playback device, such as what types of audio files the playback device is capable of playing, or to business rules that set up other constraints for what files may be downloaded to a particular playback device. The application server received information about the type of playback device and the available storage space from the download manager when the user logged into his or her account, and can query the device database, user database, and usage rights database for other information. If the requested audio files cannot be played back on the device, an error message will be displayed in the user's browser (215) and if the problem can be corrected, the user is asked to do so. For example, if the problem is that there is not enough empty storage space left on the playback device to download a particular audio file, the user will be asked to delete one or more of the audio files residing on the playback device. The user can request deleting or rearranging audio files through his or her web browser. The user submits an appropriate request to the application server through the web server, and the application server translates the user request into instructions that are sent to the download manager, which in turn carries out the instructions on the playback device through the interfaces described above.

If the check is successful and the requested audio files are playable on the playback device, the application server submits a request for the audio files to the content database (220). The application server also submits a request for licenses (that is, decryption keys with additional usage information) from the license server (225). Each audio file in the content database is encrypted and the audio file's corresponding key pair resides in the rights database. The license server communicates with the rights database and generates a license that is good for a single export of an audio file to a device, and sends this license to the application server in response to the request. The application server also receives the encrypted audio file or audio files from the content database.

At the application server, the received license is converted into a master license that is distributed to the pass-through device together with the encrypted audio file or audio files (235). The master license is only usable by the pass-through device, so if a user tries to copy the downloaded audio file (with or without the master license) to a different computer or pass-through device, the copied audio file will not be usable on that target device. Optionally the master license may contain instructions that make the audio files playable on the pass-through device, or instructions that allow the user to burn a compact disk from the received audio files.

When the master license and the corresponding encrypted audio file has been downloaded to the pass-through device, the download manager will retarget the master license to the destination playback device, thus making the audio file playable only on the playback device (235).

Finally the retargeted licenses and audio files are transferred to the playback device (240) where the audio files can be played back at any time, which concludes the first example of downloading audio files using the closed loop system.

As shown in FIG. 2B, the process (245) for downloading audio files in a closed loop system using the Intertrust DRM technology is essentially the same as the process described in FIG. 2 for the steps 250 to 265. However, when an audio file is packaged using the Intertrust DRM technology, the audio file is packaged with self-contained offers that allow certain actions, such as play, transfer to a device, bum to a compact disk, and so on. These offers can be examined by the application server with the use of a software application called InterRights Point (IRP) residing on the application server. The IRP examines the offers associated with the audio files and generates decryption keys to unlock the content as allowed by the offers (270) embedded in the audio files.

Another software module that resides on the application server is called RightsPD writer. The application server decrypts the audio files using the generated decryption keys and then the RightsPd writer re-encrypts the decrypted audio files into a format that is only playable on a device having a RightsPD reader (275). More particularly, during the re-encryption of audio files, the audio files are re-encrypted using the playback device ID or storage medium ID as a key, which makes the audio files playable only on the playback device or storage that is attached to the computer network, provided that the device has a RightsPD reader. In other words, the conversion to a unique audio file format is performed at the application server in the Intertrust implementation, but at the computer or pass-through device in the Microsoft implementation. Finally the re-encrypted audio files are transferred to the playback device (280) over the computer network for subsequent playback. This completes the implementation of the closed loop delivery system using the Intertrust DRM system.

In both the Microsoft and Intertrust implementations, the downloaded audio files stay on the digital audio playback device until they are deleted. The deletion of the audio files can either be requested by the user, as was described above, or be automatically performed by the application server. The application server (160) keeps a record in the user database (145) for each user of what tracks have been downloaded to his or her devices. In some cases, for example, as a part of a promotion or a timed subscription, the downloaded files can be used only for a specific time period. When this time period expires, the application server (140) will issue a delete command to the download manager (120, 125) immediately upon the next authentication, and the corresponding audio files will be deleted from the digital audio playback device.

A number of embodiments of the invention have been described. Nevertheless, it will be understood that various modifications may be made without departing from the spirit and scope of the invention. For example, the databases and the license server can be integrated into one unit. The media content can be delivered in a format that is not adapted to a particular playback device, but that can be played on any playback device of a particular type and still have certain associated usage rules, such as a limited number of downloads by a particular user or only being playable for a certain time period, and so on. Also, the content database may be a secure facility where the media content is stored in an unencrypted format. The application server can then retrieve the unencrypted content and the license server can manufacture a license (or the application server can embed rights into the media file as described above) before the media file is downloaded to a particular playback device. Accordingly, other embodiments are within the scope of the following claims.

What is claimed is:

1. A system for delivery of media files to a particular digital media playback device, comprising:
a content server operable to:
receive device-identifying information obtained from a particular digital media playback device, and
distribute media files in response to the received device-identifying information; and
a download manager located in the digital media playback device, the download manager being operable to:
forward device-identifying information to the content server over a public communication network; and
receive media files over the public communication network from the content server for playback on the particular digital media playback device.

2. The system of claim 1, wherein the content server comprises:
a user database containing user information uniquely identifying one or more users;
a content database containing multiple media files and metadata associated with each media file of the multiple media files;
a usage rights database containing usage rights information for each media file in the content database;
a license server for issuing content-enabling licenses;
a device database containing device information uniquely identifying one or more device types; and
an application server operable to communicate with the user database, the content database, the license server, the usage rights database, the device database and the download manager.

3. The system of claim 2, wherein the application server is operable to perform the following steps in response to a request for one or more media files from the download manager:
obtain user information from the user database based on the device-identifying information;
obtain one or more encrypted media files and metadata associated with the encrypted media files from the content database;
obtain usage rights information for the one or more encrypted media files from the usage rights database;
obtain device information from the device database, the device information describing functional capabilities of the digital media playback device;
forward the obtained user and device information to the license server and receive a license for the encrypted digital media files; and
distribute the encrypted media files and the license to the download manager over the public communication network.

4. The system of claim 2, wherein the application server is operable to perform the following steps in response to a request for one or more media files from the download manager:
obtain user information from the user database based on the device-identifying information;
obtain one or more encrypted media files and metadata associated with the encrypted media files from the content database;
obtain usage rights information for the one or more media files from the usage rights database;
obtain device information from the device database, the device information describing functional capabilities of the digital media playback device;
forward the obtained user information to the license server and receive a license for the encrypted media;
decrypt the encrypted media files using the received license;
re-encrypt the decrypted media files, using the device information and usage rights information, to a file format that is playable only on the particular digital media playback device; and
distribute the re-encrypted media files to the download manager over the public communication network.

5. The system of claim 2, wherein the application server is operable to perform the following steps in response to a request for one or more media files from the download manager:
obtain user information from the user database based on the device-identifying information;
obtain one or more media files and metadata associated with the media files from the content database;
obtain usage rights information for the one or more media files from the usage rights database;
obtain device information from the device database, the device information describing functional capabilities of the digital media playback device;
forward the obtained user and device information to the license server and receive a license for the digital media files; and
distribute the media files and the license to the download manager over the public communication network.

6. The system of claim 2, wherein the application server is operable to perform the following steps in response to a request for one or more media files from the download manager:
obtain user information from the user database based on the device-identifying information;
obtain one or more media files and metadata associated with the media files from the content database;
obtain usage rights information for the one or more media files from the usage rights database;
obtain device information from the device database, the device information describing functional capabilities of the particular digital media playback device;
encrypt the media files, using the device information and usage rights information, to a file format that is playable only on the digital media playback device; and
distribute the encrypted media files to the download manager over the public communication network.

7. The system of claim 2 wherein the user database further contains offer information.

8. The system of claim 2, wherein the device database contains device information uniquely identifying one or more type of devices, the device information comprising make, model, manufacturer, and functional characteristics.

9. The system of claim 2, wherein the content server further comprises a web server that is connected to the application server and to the public communication network, thereby allowing a user to communicate with the content server through a web browser.

10. The system of claim 9, wherein the web server further is operable to provide representations of media files that are playable on the particular digital media playback device, the representations being operable to be viewed by the user in the web browser.

11. The system of claim 9, wherein the application server further is operable to:
receive user requests for controlling the function of the digital media playback device, the user requests being supplied by a user through the web browser; and
generate control commands to the download manager, the control commands instructing the download manager to carry out the user requests on the digital media playback device.

12. The system of claim 1, wherein the media file formats include MP3 files, WMA files, SAF files, BMT files, RM files, and VQF files.

13. The system of claim 1, wherein the digital media playback device is a portable device for playback of media files.

14. The system of claim 1, wherein the digital media playback device is a non-portable home sound reproduction system.

15. The system of claim 1, wherein the digital media playback device is a cellular telephone.

16. The system of claim 1, wherein the digital media playback device comprises a television set top box.

17. The system of claim 1, wherein the digital media playback device is a web pad.

18. The system of claim 1, wherein the digital media playback device is an Internet radio device.

19. The system of claim 1, wherein the digital media playback device is a hybrid device.

20. The system of claim 1, wherein the digital media playback device is a digital media playback module.

21. The system of claim 1, wherein the device-identifying information is obtained from a removable nonvolatile storage medium in the digital media playback device.

22. The system of claim 1, wherein the device-identifying information comprises a unique identification number obtained from the digital media playback device.

23. The system of claim 22, wherein the unique identification number is a serial number.

24. The system of claim 1, wherein the device-identifying information further comprises a state of a nonvolatile storage medium in the digital media playback device.

25. The system of claim 1, wherein the public communication network is the Internet.

26. A method for delivery of media files to a particular digital media playback device, comprising:
forwarding device-identifying information from a download manager located in a particular digital media playback device to a content server over a public communication network;
receiving the device-identifying information at the content server;
distributing media files from the content server to the download manager in response to the received device-identifying information; and
receiving the media files at the download manager for playback on the particular digital media playback device.

27. The method of claim 26, wherein distributing media files comprises:
obtaining user information from a user database based on the device-identifying information;
obtaining one or more encrypted media files and metadata associated with the encrypted media files from a content database;
obtaining usage rights information for the selected media files from a usage rights database;
obtaining device information from a device database, the device information describing functional capabilities of the digital media playback device;
forwarding the obtained user and device information to a license server and receiving a license for the encrypted digital media files; and
distributing the encrypted media files and the license to the download manager over the public communication network.

28. The method of claim 26, wherein distributing media files comprises:
obtaining user information from a user database based on the device-identifying information;
obtaining one or more encrypted media files and metadata associated with the encrypted media files from a content database;
obtaining usage rights information for the one or more media files from a usage rights database;
obtaining device information from a device database, the device information describing functional capabilities of the digital media playback device;
forwarding the obtained user information to a license server and receiving a license for the encrypted media files;
decrypting the encrypted media files using the license;
re-encrypting the decrypted media files, using the device information and the usage rights information, to a file format that is playable only on the particular digital media playback device; and
distributing the re-encrypted media files to the download manager over the public communication network.

29. The method of claim 26, wherein distributing media files comprises:
obtaining user information from a user database based on the device-identifying information;
obtaining one or more media files and metadata associated with the media files from a content database;
obtaining usage rights information for the selected media files from a usage rights database;
obtaining device information from a device database, the device information describing functional capabilities of the digital media playback device;
forwarding the obtained user and device information to a license server and receiving a license for the digital media files; and
distributing the media files and the license to the download manager over the public communication network.

30. The method of claim 26, wherein distributing media files comprises:
obtaining user information from a user database based on the device-identifying information;
obtaining one or more media files and metadata associated with the media files from a content database;
obtaining usage rights information for the one or more media files from a usage rights database;
obtaining device information from a device database, the device information describing functional capabilities of the digital media playback device;
encrypting the media files, using the device information and usage rights information, to a file format that is playable only on the particular digital media playback device; and
distributing the encrypted media files to the download manager over the public communication network.

31. The method of claim 26, further comprising:
displaying representations of media files that are playable on the digital media playback device to a user in a web browser.

32. The method of claim 26, further comprising:
receiving user requests for controlling the function of the particular digital media playback device, the user requests being supplied by a user through a web browser; and
generating control commands to the download manager, the control commands instructing the download manager to carry out the user requests on the particular digital media playback device.

33. The method of claim 26, wherein obtaining device-identifying information comprises:
obtaining device-identifying information from a removable nonvolatile storage medium in the digital media playback device.

34. The method of claim 26, wherein obtaining device-identifying information comprises:
obtaining a unique identification number from the digital media playback device.

35. The method of claim 26, further comprising:
obtaining a state of a nonvolatile storage medium in the digital media playback device.
